(19) United States
(12) Patent Application Publication
(10) Pub. No.: US 2024/0164512 A1
(43) Pub. Date: May 23, 2024

(54) BRUSH HEAD FOR AN ORAL HYGIENE DEVICE

(71) Applicant: Mohammad DEILAMI, Calgary (CA)

(72) Inventor: Mohammad DEILAMI, Calgary (CA)

(21) Appl. No.: 18/283,420

(22) PCT Filed: Mar. 21, 2022
(86) PCT No.: PCT/CA2022/050418

§ 371 Date: Sep. 21, 2023

Related U.S. Application Data
(60) Provisional application No. 63/164,443, filed on Mar. 22, 2021.

(51) Int. Cl. A46B 5/00; A61C 17/34

(52) U.S. Cl. CPC A46B 5/0095; A61C 17/34

(57) ABSTRACT

The present disclosure generally relates to a brush head for an oral hygiene device. More specifically, the present disclosure relates to a brush head with magnetic attachment mechanisms for repeatedly attaching and detaching a connector to a cleaning element of the brush head and magnetic attachment mechanisms for repeatedly attaching and detaching the connector to a handle of the oral hygiene device.

### CROSS-REFERENCE TO RELATED APPLICATION

This application claims the benefit of U.S. Provisional Patent Application Ser. No. 63/164,443 filed on Mar. 22, 2021. The contents of the aforementioned application are incorporated by reference herein.

### TECHNICAL FIELD

The present disclosure generally relates to a brush head for an oral hygiene device. More specifically, the present disclosure relates to a brush head including a connector and a cleaning element operable to be repeatedly attached to and detached from one another as well as to a handle of the oral hygiene device.

### BACKGROUND

Oral hygiene devices, such as manual and electric toothbrushes, are well known. Such toothbrushes may have a brush head permanently or detachably coupled to a handle. Generally, tufts of bristles or other cleaning elements for cleaning teeth and soft tissue in the mouth are attached to a bristle carrier or mounting surface of the brush head for insertion into a user's oral cavity. The handle is usually attached to the brush head and is held by a user during brushing. After the usual lifetime of a toothbrush, i.e. after about three months of usage, the toothbrush is often discarded. In order to provide environmentally friendly/sustainable toothbrushes generating less waste when the brushes are discarded, toothbrushes have been developed having heads or head refills that are exchangeable, i.e. can be repeatedly attached to and detached from the handle. Thus, instead of buying a completely new toothbrush, consumers can re-use the handle and only have to buy a new head refill. Such refills are usually less expensive and generate less waste than a conventional toothbrushes.

For an electric toothbrush, the brush head may be coupled to the handle by a coupling, which functions to transfer motion generated by the handle to the tufts of bristles. Such motion may be a rotating oscillating motion or a sonic or ultrasonic vibration generated by an electric motor in the handle to the bristles. In practice, such couplings, usually mechanical, may be inefficient and difficult to clean, resulting in poor connectivity, power loss and generation of unnecessary noise during operation of the device. Thus, it would be desirable to provide a coupling between portions of an oral hygiene device which overcomes one or more of such above-mentioned drawbacks.

### SUMMARY

The present disclosure provides a connector for repeatedly attaching to and detaching from a handle portion and for repeatedly attaching to and detaching from a cleaning element of an oral hygiene device. The connector includes a housing having a proximal end and a distal end; a first attachment mechanism positioned at the proximal end of the housing, the first attachment mechanism including a proximal coupling structure configured for establishing a connection with a first coupling structure provided on the handle portion; and a second attachment mechanism positioned at the distal end of the housing, the second attachment mechanism including a distal coupling structure configured for establishing a connection with a second coupling structure provided on the cleaning element. The proximal coupling structure includes a magnetic element capable of magnetically coupling with a corresponding magnetic element carried by the first coupling structure and the distal coupling structure includes a magnetic element capable of magnetically coupling with a corresponding magnetic element carried by the second coupling structure. In some embodiments, the distal coupling structure includes an engagement device capable of mechanically coupling with a corresponding housing carried by the second coupling structure.

The present disclosure also provides a brush head including the connector and a cleaning element and a kit including the connector and a plurality of cleaning elements.

### BRIEF DESCRIPTION OF THE DRAWINGS

FIG. 1 is a schematic block diagram of an oral hygiene device according to an embodiment of the present disclosure;

FIG. 2A is a top plan view of an oral hygiene device according to a second embodiment of the present disclosure;

FIGS. 2B and 2C are side and top plan views of the brush head of the oral hygiene device of FIG. 2A;

FIG. 3A is a top plan view of an oral hygiene device according to a third embodiment of the present disclosure;

FIG. 3B is a top perspective view of the handle portion of the oral hygiene device of FIG. 3A;

FIG. 3C is an enlarged, partially disassembled view of the oral hygiene device of FIG. 3A;

FIG. 3D is a top perspective view of a first collar of the oral hygiene device of FIG. 3A;

FIG. 3E is a top perspective view of the cleaning element of the oral hygiene device of FIG. 3A;

FIG. 4A is a top perspective view of a brush head according to an embodiment of the present disclosure;

FIG. 4B is a top perspective view of the connector of the brush head of FIG. 4A;

FIGS. 4C and 4D are top perspective and side perspective views of the cleaning element of the brush head of FIG. 4A;

FIGS. 5A and 5B are top perspective views of cleaning elements suitable for use with the oral hygiene devices of the present disclosure.

FIG. 6A is a top perspective view of a brush head according to another embodiment of the present disclosure;

FIG. 6B is a top perspective view of the connector of the brush head of FIG. 6A;

FIG. 6C is a top perspective view of the cleaning element of the brush head of FIG. 6A.

FIG. 7A is a top plan view of a brush head according to another embodiment of the present disclosure; and

FIGS. 7B and 7C are partially disassembled top plan views of the brush head of FIG. 7A; and

FIG. 8 is a top perspective view of a brush head according to another embodiment of the present disclosure.

FIGS. 9A and 9B are top perspective and side perspective view of a connector according to another embodiment of the present disclosure.

FIGS. 10A and 10B are top and bottom perspective views of a cleaning element according to another embodiment of the present disclosure.

FIGS. 11A and 11B are top and bottom perspective views of a cleaning element according to another embodiment of the present disclosure.

FIGS. 12A and 12B are bottom perspective views of a cleaning element according to another embodiment of the present disclosure.

FIG. 13 is a bottom perspective view of a cleaning element according to another embodiment of the present disclosure.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments.

Reference in this specification to “one embodiment” or “an embodiment” means that a particular feature, structure, or characteristic described in connection with the embodiment is included in at least one embodiment of the-disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

As used in this specification and the appended claims, the words “proximal” and “distal” refer to directions closer to and away from, respectively, the user of the oral hygiene device. The words “upward”, “downward”, “upper”, “lower”, “right” and “left” designate directions in the drawings to which reference is made. The words “inward” and “outward” refer to directions toward and away from, respectively.

The terms “attach” and/or “attached” may refer to its common dictionary definition where appropriate, but it may contextually refer to particular acts of connecting, associating, affixing, fastening, sticking, or any combination of the foregoing that cause an object to be fixedly or selectively proximate another object.

The terms “connect”, “connected”, and/or “connecting” means either an indirect or direct connection. Thus, if a first device is connected to a second device, that connection may be through a direct connection or through an indirect connection via other devices and connections.

The present disclosure is generally directed to a brush head for use with an oral hygiene device. More specifically, the present disclosure relates to a brush head configured to be repeatedly attached to and detached from a handle of the oral hygiene device. The oral hygiene device may be used for cleaning, whitening, removing plaque or other oral hygiene applications. The brush head generally includes a connector and a cleaning element. The connector includes a first attachment mechanism for repeatedly attaching the connector to the handle and repeatedly detaching the connector from the handle. The connector also includes a second attachment mechanism for repeatedly attaching the connector to the cleaning element and repeatedly detaching the connector from the cleaning element. The first and second attachments mechanisms are magnetic attachment mechanisms configured to easily attach and couple the cleaning element and handle to the connector to enable a user to perform for e.g. a brushing, flossing or scraping action. When the cleaning element is worn out or a different type of dental hygiene task is to be performed, the second attachment mechanism enables the cleaning element to be detached from the connector and a second cleaning element to be attached to the connector without affecting the first attachment mechanism or an attachment between the handle and the connector. This advantageously allows a plurality of cleaning elements to be quickly and easily changed while utilizing the same connector and handle, thus minimizing plastic waste and reducing cost for the user.

As discussed above, the cleaning element and handle of the oral hygiene device are repeatedly attachable to and detachable from the connector via the first and second attachment mechanisms. The handle has a first coupling structure configured to connect to the first attachment mechanism. The first attachment mechanism includes a magnetic element that is magnetically coupled to a corresponding magnetic element in the first coupling structure when the first attachment mechanism is connected to the first coupling structure. The cleaning element has a second coupling structure configured to connect to the second attachment mechanism. The second attachment mechanism includes a magnetic element that is magnetically coupled to a corresponding magnetic element in the second coupling structure when the second attachment mechanism is connected to the second coupling structure. The magnetic elements may be permanent magnets or magnetizable materials (for e.g. magnetizable steel or iron) and the magnetic couplings form between permanent magnets or a permanent magnet and magnetizable material. In some embodiments, the magnetic couplings are formed between permanent magnets to ensure a sufficiently strong connection and stability between the cleaning element, handle and connector as compared to a permanent magnet/magnetizable material combination.

The first attachment mechanism includes a proximal coupling structure configured and shaped to establish a connection to the first coupling structure provided on the handle. A magnetic element is attached to the proximal coupling structure. When the proximal coupling structure is connected to the first coupling structure, the magnetic element is magnetically coupled with, via an attractive force, a corresponding magnetic element in the first coupling structure. Similarly, the second attachment mechanism includes a distal coupling structure configured and shaped to establish a connection to the second coupling structure provided on the cleaning element. A magnetic element is attached to the distal coupling structure. When the distal coupling structure is connected to the second coupling structure, the magnetic element is magnetically coupled with, via an attractive force, a corresponding magnetic element in the second coupling structure. In some embodiments, the magnetic element attached to the proximal coupling structure and distal coupling structure is a neodymium magnet (i.e. a permanent magnet comprised of an alloy of neodymium, iron and boron). The corresponding magnetic elements in the first and second coupling structure can be characterized by a magnetic dipole oriented relative a magnetic dipole of the neodymium magnets. When the proximal and distal coupling structures are connected to the first and second coupling structures, an attractive force is generated between the neodymium magnets of the proximal and distal coupling structures and the corresponding magnets of the first and second coupling structures. The magnetic elements may have any shape such as cylindrical, square, rectangular, triangular or other polygonal shape.

In some embodiments, the proximal coupling structure and distal coupling structure may be cylindrically shaped. In other embodiments, the proximal coupling structure and distal coupling structure can be rectangular, triangular, or any other regular or irregular shape that conforms to the capability of establishing a connection with the first and second coupling structures. Similarly, the first and second coupling structure may have a shape complimentary to the proximal and distal coupling structures.

In some embodiments, the proximal coupling structure may have a recess therein, the recess forming a cavity to at least partly accommodate the magnetic element. The recess may also have an inner wall with a geometry/contour which corresponds to the outer geometry/contour of the first coupling structure of the handle to be inserted into the recess. In different embodiments, the first coupling structure may have a recess therein, the recess forming a cavity to at least partly accommodate the corresponding magnetic element. The recess may also have an inner wall with a geometry/contour which corresponds to the outer geometry/contour of the proximal coupling structure of the connector to be inserted into the recess

Similarly, the distal coupling structure may also have a recess therein, the recess forming a cavity to at least partly accommodate the magnetic element. The recess may also have an inner wall with a geometry/contour which corresponds to the outer geometry/contour of the second coupling structure of the handle to be inserted into the recess. In different embodiments, the second coupling structure may have a recess therein, the recess forming a cavity to at least partly accommodate the corresponding magnetic element. The recess may also have an inner wall with a geometry/contour which corresponds to the outer geometry/contour of the distal coupling structure of the connector to be inserted into the recess

Once the handle and connector are operatively engaged, the handle is fixed to the connector along the connector's axis and once the cleaning element and connector are operatively engaged, the cleaning element is fixed to the connector along the connector's axis or at an angle equal to or less than 90° along the connector's axis. The first and second attachment mechanisms provide a precise fixation of the connector, cleaning element and handle. Prior to fixation, a distinct haptic feedback is given to the user such that the magnetic fields generated by the magnetic elements provide a “homing function” that aids a person in aligning the first and second attachment mechanisms with the handle and connector. The magnetic connections formed are sufficiently strong enabling well-coordinated brushing and cleaning techniques (i.e. the cleaning element does not get loosened from the connector and handle and does not twist aside during brushing or cleaning). The cleaning element and handle, independently, can be easily removed from the connector by a simple pulling motion that provides a force sufficient to overcome the magnetic connection between permanent magnets or permanent magnet/magnetizable material without having to perform a synchronized action with other elements/unlocking mechanisms.

In one embodiment, the connector and a plurality of cleaning elements may be combined in a kit and used in connection with a commercially available handle for undertaking several oral hygiene tasks. The cleaning elements may include, but are not limited to, a floss pick, a gum stimulator, an interdental brush and a tongue scraper. The kit, when combined with the handle, allows a user to more rapidly and efficiently perform a variety of oral hygiene tasks.

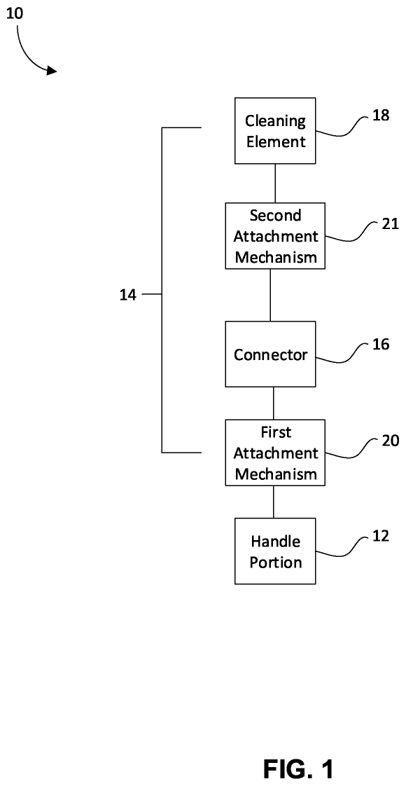

Referring now to the drawings, which are for purposes of illustrating the present invention and not for purposes of limiting the same, FIGS. 1-5 depict a manual or electric toothbrush having a handle portion and a brush head including a connector having first and second attachment mechanisms and a cleaning element. The handle, connector and cleaning element are operatively connected via the first and second attachment mechanisms. In embodiments for electrical toothbrushes or other electrical oral hygiene devices, it will be understood that the electrical components of the handle portion and the components transmitting motion (e.g., rotational motion) to the cleaning element are known. Therefore, a discussion of these components will either be described generally or omitted. However, it should be understood that when the connector and cleaning element are docked with the handle portion, internal components on each come into mechanical communication, which allows the power supplied by the electrical components to rotate the cleaning element.

With reference now to FIG. 1, a schematic diagram of an oral hygiene device 10 according to an embodiment of the present disclosure is shown. The oral hygiene device 10 generally includes a body or handle portion 12 and a brush head 14. Brush head 14 includes a connector 16 having a first attachment mechanism 20 and a second attachment mechanism 21 and a cleaning element 18. The first attachment mechanism 20 is configured for repeatedly attaching or detaching the handle portion 12 and connector 16 and the second attachment mechanism 21 is configured for repeatedly attaching or detaching the cleaning element 18 and the connector 16. Cleaning element 18 may include a tuft of bristles and/or elastomeric element fixed thereon for cleaning at least one tooth and/or oral tissues. The oral hygiene device 10 may be a manual or electric toothbrush, or alternatively an inter-proximal pick, a plaque scraper, tissue/tongue cleanser or any other known device for cleaning teeth/oral tissues.

The first attachment mechanism 20 may be attached to or positioned at the connector's proximal end. The first attachment mechanism 20 may include a proximal coupling structure configured and shaped to attach or establish a connection with a first coupling structure provided on the handle portion 12. A magnetic element is attached to or at least partly embedded within the proximal coupling structure. In some embodiments, the magnetic element is a cylindrical permanent magnet having a magnetic dipole oriented substantially parallel to or collinear with the central axis of the proximal coupling structure.

The second attachment mechanism 21 may be attached to or positioned at the connector's distal end. The second attachment mechanism 21 may include a distal coupling structure configured and shaped to attach or establish a connection with a second coupling structure provided on the cleaning element 18. A magnetic element is attached to or at least partly embedded within the distal coupling structure. In some embodiments, the magnetic element is a cylindrical permanent magnet having a magnetic dipole oriented substantially parallel to or collinear with the central axis of the distal coupling structure.

The connector 16 may have a generally cylindrical shape, although other shapes such as rectangular, triangular, or any other regular or irregular shape are possible.

The handle portion 12 includes the first coupling structure attached or positioned at the handle portion's distal end. A magnetic element is attached to or at least partly embedded within the first coupling structure. In some embodiments, the magnetic element is a cylindrical permanent magnet having a magnetic dipole oriented substantially parallel to or collinear with the central axis of the first coupling structure.

The cleaning element 18 includes a body and the second coupling structure attached or positioned at the body's proximal end. A magnetic element is attached to or at least partly embedded within the second coupling structure. In some embodiments, the magnetic element is a cylindrical permanent magnet having a magnetic dipole oriented substantially parallel to or collinear with the central axis of the second coupling structure.

The magnetic elements may be fixedly attached to the above described coupling structures by any means known in the art, such as by press fitting or an adhesive.

In an embodiment, oral hygiene device 10 may be an electric toothbrush and handle portion 12 may be configured to be gripped by a hand of the user and also to generate a motion that is transferred to a drive element in connector 16 through first attachment mechanism 20. The drive element is operable to transfer the motion to cleaning element 18 through the second attachment mechanism 21. In operation, the first and second attachment mechanisms 20, 21 operate as motion transmitters, transferring the motion from the handle portion 12 to cleaning element 18. As will be described in further detail below, the motion may be a rotating oscillating motion or a vibratory motion.

The above described magnetic elements, when coupled, have a coupling force that is greater than an operational force that may be applied to the first and second attachment mechanisms 20, 21. The operational force may be any force that is applied to the first and second attachment mechanisms 20, 21 during use of the oral hygiene device 10. For example, such forces may be generated from friction between bristles of the cleaning element as they engage the teeth or gums within the oral cavity of the user. Said another way, the strength of coupling force is sufficient to maintain magnetic coupling between handle portion 12, connector 16 and cleaning element 18 as forces are applied to the first and second attachment mechanisms 20, 21 during operation.

Further, the coupling force of the magnetic coupling between the connector 16 and handle portion 12 is less than a pull off force applied to connector 16 by a user in order to remove connector 16 from handle portion 12. Similarly, the coupling force of the magnetic coupling between the connector 16 and cleaning element 18 is less than a pull off force applied to the cleaning element 18 by a user in order to remove cleaning element 18 from connector 16.

In various embodiments the coupling force between the connector 16 and the handle portion 12 may be lesser, greater or equal to the coupling force between the connector 16 and the cleaning element 18.

In an embodiment, each of the magnetic elements may be permanent magnets. The proximal coupling structure of connector 16 may be configured such that when it is placed in close proximity to the first coupling structure provided on handle portion 12, attractive forces generated by the permanent magnets on or at least partly embedded within the coupling structures cause connector 16 and handle portion 12 to be drawn towards one another and the coupling structures engage to establish a connection and a secure magnetic coupling. Similarly, the distal coupling structure of connector 16 may be configured such that when it is placed in close proximity to the second coupling structure provided on cleaning element 18, attractive forces generated by the permanent magnets on at least partly embedded within the coupling structures cause connector 16 and cleaning element 18 to be drawn towards one another and the coupling structures engage to establish a connection and a secure magnetic coupling. Thus, the user can attach the handle and connector and the connector and cleaning element without having to physically interlock such components of the oral hygiene device 10.

In some embodiments, the connector and handle are coupled solely by the first attachment mechanism and the connector and cleaning element are coupled solely by the second attachment mechanism.

In an embodiment, oral hygiene device 10 is a rotating oscillating electric toothbrush and handle portion 12 includes an energy source such as a rechargeable or non-rechargeable battery to power a DC motor having gearing to convert the rotating motion generated by the motor into an oscillating rotation motion. The oscillating rotation motion is transferred to a drive element in connector 16 by first attachment mechanism 20. Similar to that described above, the drive element is operable to transfer the motion through the connector 16 and through the second attachment mechanism 21 to cleaning element 18.

In an embodiment, oral hygiene device 10 is a sonic or ultrasonic toothbrush which generates a high frequency vibration wave to the drive shaft of the handle portion 12. The high frequency vibration may be generated by means such as a piezo electric crystal, powered by an energy source such as a rechargeable or non-rechargeable battery within handle portion 12. As known to those skilled in the art, sonic toothbrushes may typically produce vibrations that range from 200 to 400 Hz and ultrasonic toothbrushes may typically produce vibrations that range from 20000 Hz to 1.6 MHz

In various embodiments handle portion 12 may include additional features such timers, sensors, indicia, cleaning modes, wireless charging and Bluetooth connectivity as known to those skilled in the art.

In other embodiments, oral hygiene device 10 may be a manual toothbrush with handle portion 12 configured to be used solely as a handle for gripping by the user.

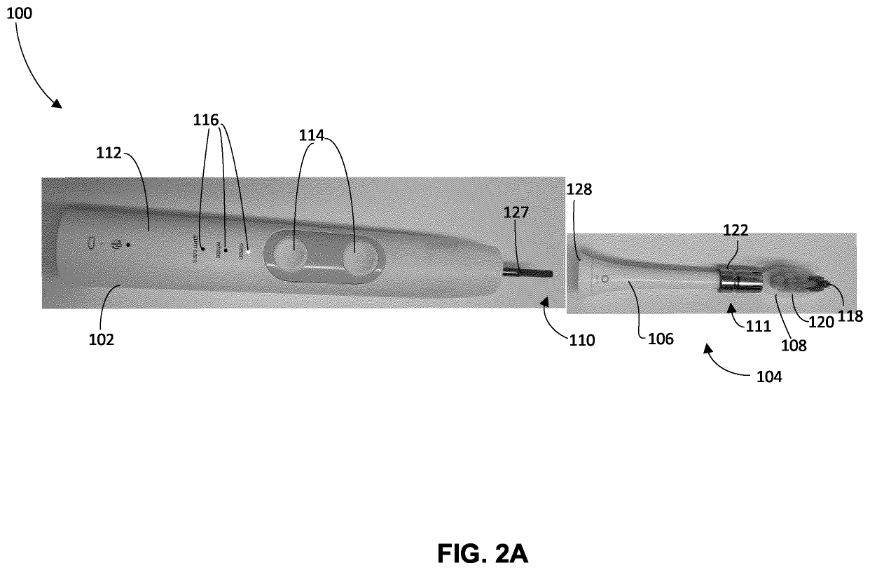

With reference now to FIGS. 2A-C, an electric toothbrush according to an embodiment of the present disclosure is shown generally as 100. Electric toothbrush 100 may be a sonic or ultrasonic electric toothbrush which may include a handle portion 102 and a brush head 104, the brush head being configured to be removably attached to or detached from handle portion 102.

Handle portion 102 may have a generally cylindrical elongated housing 112 with a cavity therein in which various internal components, including, but not limited to, those described above are located. As is known to those skilled in the art, housing 112 may house a rechargeable battery or non-rechargeable battery and electronic components operable to generate a high frequency linear or vibratory drive output. On the outer surface of housing 112, there may be buttons 114 configured and operable to activate electric toothbrush 100 or adjust between different cleaning modes. Lights 116 may indicate to a user information such as cleaning mode, battery charge or when to change or replace the brush head, for example. Handle portion 102 further includes a first coupling structure attached to positioned at the handle portion's distal end. In the embodiment shown in FIGS. 2A-2C, the first coupling structure has a cylindrical shape. The first coupling structure includes a permanent magnet 127 attached to or at least partly embedded within the first coupling structure.

Brush head 104 includes a connector 106 and a cleaning element 108. Connector 106 comprises a housing which may house a drive element (not shown), extending longitudinally therein. Connector 106 also includes a first attachment mechanism 110 attached to or positioned at the connector's proximal end. Connector 106 is configured to be repeatedly attached to and detached from handle portion 102 via the first attachment mechanism 110 which is a magnetic attachment mechanism. The first attachment mechanism 110 includes a proximal coupling structure configured to attach or establish a connection with the first coupling structure of handle portion 102. In the embodiment shown in FIGS. 2A-2C, the proximal coupling structure has a cylindrical shape with a recess shaped and contoured to accept the first coupling structure of the handle portion 102. The proximal coupling structure includes a permanent magnet 128 at least partly embedded within the recess. First attachment mechanism 110 is operable to transfer the motion generated from handle portion 102 to the drive element within the housing of connector 106.

The connector 106 also includes a second attachment mechanism 111 attached to on positioned at the connector's distal end. Connector 106 is configured to be repeatedly attached to or detached from cleaning element 108 via the second attachment mechanism 111 which is a magnetic attachment mechanism. The second attachment mechanism 111 includes a distal coupling structure configured to attach or establish a connection with a second coupling structure of cleaning element 108. In the embodiment shown in FIGS. 2A-2C, the distal coupling structure has a cylindrical shape with a recess shaped and contoured to accept the second coupling structure of cleaning element 108. The distal coupling structure includes a first collar 122 that extends distally terminating at a plurality of spaced apart projections 126. The inner wall of first collar 122 forms the recess sized and shaped to house permanent magnet 129. Second attachment mechanism 111 is operable to transfer the motion generated from the drive element within the housing of connector 106 to the cleaning element 108.

Cleaning element 108 has a body that may be generally round or oval shaped, with a plurality of bristles 118 on a top face 120 operable for cleaning and massaging parts of the oral cavity such as teeth, tongue and gums. The cleaning element 108 also includes a second coupling structure attached to or positioned at the body's proximal end. The second coupling structure is configured and shaped to be inserted into the recess of the first collar 122. The second coupling structure of the cleaning element 108 may be generally cylindrically shaped and includes a second collar 124 with a permanent magnet 130 attached to or at least partly embedded within the second collar 124.

In operation, the proximal coupling structure of connector 106 is placed in close proximity to the first coupling structure provided on handle portion 102. Attractive forces generated by the permanent magnets 127, 128 on or at least partly embedded within the coupling structures cause connector 106 and handle portion 102 to be drawn towards one another and the coupling structures connect to establish a secure magnetic coupling between magnets 127, 128. Similarly, the distal coupling structure of connector 106 is placed in close proximity to the second coupling structure provided on cleaning element 108. Attractive forces generated by the permanent magnets 127, 128 on at least partly embedded within the coupling structures cause connector 106 and cleaning element 108 to be drawn towards one another and the coupling structures engage to establish a secure magnetic coupling between magnets 127, 128. Projections 126 assist with centring magnets 129, 130 along the y-axis in FIG. 2C. This may be beneficial in maximising the coupling force provided by the second attachment mechanism 111.

The drive output from handle portion 102 may be transferred to the drive element (not shown) within connector 106 through first attachment mechanism 110 and from the drive element to cleaning element 108, through second attachment mechanism 111, causing bristles 118 to vibrate. The coupling force generated by engagement of magnets 129, 130 is sufficient to be maintained during application of any operational forces as described above to second attachment mechanism 111. Furthermore, projections 126 prevent lateral movement (X and Z direction in FIG. 2C) of magnets 129, 130 relative to each other in response to any lateral forces applied to connector 106 or cleaning element 108, ensuring a secure coupling is maintained between connector 106 and cleaning element 108 during operation. The connector 106 may be detached from the handle portion 102 by applying pull force sufficient to overcome the attractive force between the permanent magnets 127, 128 in the proximal coupling structure and distal coupling structure. Similarly, connector 106 may be detached from the cleaning element 108 by applying a pull force sufficient to overcome the attractive force between the permanent magnets 129, 130 in the distal coupling structure and second coupling structure.

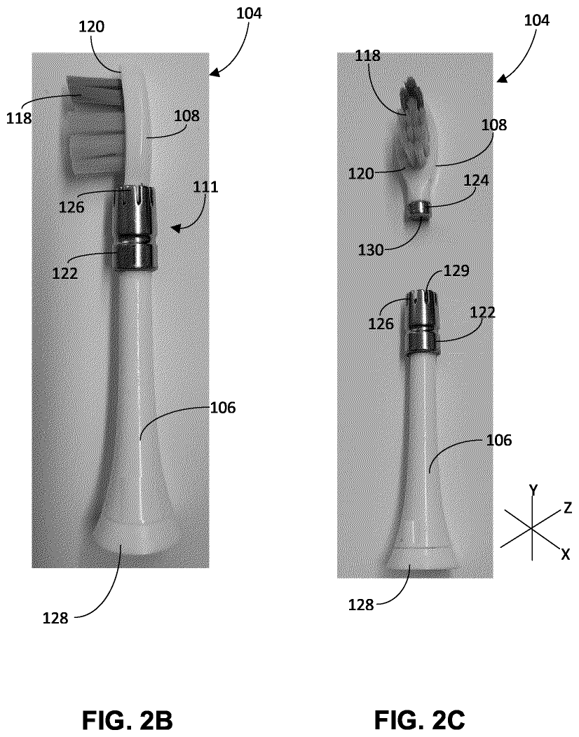

With reference now to FIGS. 3A-E a manual toothbrush 200 according to another embodiment of the present disclosure is shown. As illustrated in FIGS. 3A and 3B, toothbrush 200 may include a handle portion 202 and a brush head 204. Handle portion 202 may have an elongated profile and be configured to be gripped by the user. Handle portion 202 includes a first coupling structure attached to or positioned at the handle portion's distal end. In the embodiment shown, the first coupling structure has a cylindrical shape attached to a rectangularly shaped distal end. The first coupling structure includes a permanent magnet 227 attached to or at least partly embedded within the first coupling structure.

Brush head 204 may include a connector 206 and a cleaning element 208. Connector 206 is cylindrically shaped and has a first attachment mechanism 210 attached to or positioned at the connector's proximal end. Connector 206 is configured to be repeatedly attached to or detached from handle portion 202 via the first attachment mechanism 210 which is a magnetic attachment mechanism. The first attachment mechanism 210 includes a proximal coupling structure configured to attach or establish a connection with the first coupling structure of handle portion 202. In the embodiment shown in FIGS. 3A-3E, the proximal coupling structure has a cylindrical shape having a recess shaped and contoured to accept the first coupling structure of the handle portion 202. The proximal coupling structure includes a permanent magnet 228 at least partly embedded within the recess.

The connector 206 also includes a second attachment mechanism 211 attached to on positioned at the connector's distal end. Connector 206 is configured to be repeatedly attached to or detached from cleaning element 208 via the second attachment mechanism 211 which is a magnetic attachment mechanism. The second attachment mechanism 211 includes a distal coupling structure configured to attach or establish a connection to a second coupling structure of cleaning element 208. In the embodiment shown in FIGS. 3A-3E, the distal coupling structure has a cylindrical shape having a recess shaped and contoured to accept the second coupling structure of cleaning element 208. A permanent magnet (not shown) is housed within the recess.

Cleaning element 208 has a body that may be generally round or oval in shape, with a plurality of bristles 218 on front face 220 operable for cleaning and massaging parts of the oral cavity such as teeth, tongue and gums. The cleaning element 208 also includes a second coupling structure attached to or positioned at the body's proximal end. The second coupling structure is configured and shaped to be inserted into the recess of the distal coupling structure. The second coupling structure of the cleaning element 208 may be generally cylindrically shaped and includes a second collar 224 with a permanent magnet 230 attached to or at least partly embedded within the second collar 224.

In operation, the proximal coupling structure of connector 206 is placed in close proximity to the first coupling structure provided on handle portion 202. Attractive forces generated by the permanent magnets on or at least partly embedded within the coupling structures cause connector 206 and handle portion 202 to be drawn towards one another and the coupling structures connect to establish a secure magnetic coupling. Similarly, the distal coupling structure of connector 206 is placed in close proximity to the second coupling structure provided on cleaning element 208. Attractive forces generated by the permanent magnets on at least partly embedded within the coupling structures cause connector 206 and cleaning element 208 to be drawn towards one another and the coupling structures connect to establish a secure magnetic coupling. The connector 206 may be detached from the handle portion 202 by applying a pull force sufficient to overcome the attractive force between the permanent magnets in the proximal coupling structure and first coupling structure. Similarly, connector 206 may be detached from the cleaning element 208 by applying a pull force sufficient to overcome the attractive force between the permanent magnets in the distal coupling structure and second coupling structure.

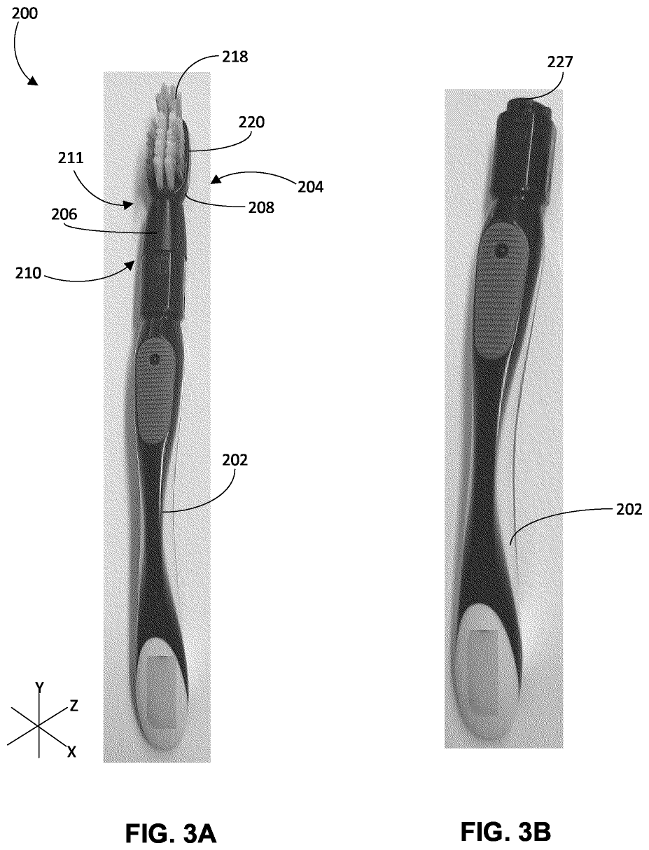

With reference now to FIGS. 4A-D, a brush head 304 suitable for use with a rotating oscillating electric toothbrush is illustrated. In this embodiment, the handle portion (not pictured) of the electric toothbrush may be configured and operable to generate a linear or rotating oscillating motion. The handle portion includes a first coupling structure positioned on or attached at the handle portion's distal end. The first coupling structure is configured and shaped to attach to or have a recess for establishing a connection with a proximal coupling structure of connector 306. The first coupling structure includes a magnetic element positioned on or at least partly embedded within the first coupling structure.

Brush head 304 may include a connector 306 and a cleaning element 308. Connector 306 may contain a drive element (not shown), extending longitudinally within a cavity of connector 306 and operable for transmitting the linear or oscillatory movement from handle portion (not shown) to the cleaning element 306, causing cleaning element 306 to oscillate as indicated by double arrow A in FIG. 4A. Connector 306 also includes a first attachment mechanism 310 attached to or positioned at the connector's proximal end. Connector 306 is configured to be repeatedly attached to or detached from handle portion via the first attachment mechanism 310 which is a magnetic attachment mechanism. The first attachment mechanism 310 includes a proximal coupling structure configured to attach or establish a connection to the first coupling structure of handle portion. In the embodiment shown in FIGS. 4A-4B, the proximal coupling structure has a cylindrical shape configured to connect to or be received within the first coupling structure of the handle portion. The proximal coupling structure includes a permanent magnet 328 attached on or at least partly embedded within a recess of the proximal coupling structure. First attachment mechanism 310 is operable to transfer the motion generated from handle portion to the drive element within the cavity of connector 306.

The connector 306 also includes a second attachment mechanism 311 attached to on positioned at the connector's distal end and orientated in a perpendicular direction to the connector's longitudinal direction. Connector 306 is configured to be repeatedly attached to or detached from cleaning element 308 via the second attachment mechanism 311 which is a magnetic attachment mechanism. The second attachment mechanism 311 includes a distal coupling structure configured to attach or establish a connection to a second coupling structure of cleaning element 308. In the embodiment shown in FIGS. 4A-4B, the distal coupling structure has a cylindrical shape to connect to the second coupling structure of cleaning element 308. The distal coupling structure includes a permanent magnet 329 orientated such that its magnetic dipole is oriented substantially perpendicular with the central axis of connector 306. Second attachment mechanism 311 is also operable to transfer the motion generated from the drive element within the housing of connector 306 to the cleaning element 308.

Cleaning element 308 has a body that may be generally round in shape, with a plurality of bristles 318 on front face 320 operable for cleaning and massaging parts of the oral cavity such as teeth, tongue and gums. The rear face of cleaning element 308 may be releasably attached to and detached from connector 306 by the second attachment mechanism 311. As described above, second attachment mechanism 311 may be aligned with a longitudinal axis that is perpendicular to the central axis of connector 306. As a result, the bristles 318 of cleaning element 308 will project in a direction perpendicular to the central axis of connector 306.

The cleaning element 308 also includes a second coupling structure attached to or positioned at the cleaning element's proximal end. The second coupling structure is configured and shaped to be attached or establish a connection to the distal coupling structure. The second coupling structure of the cleaning element 308 may be generally cylindrically shaped and includes a collar 331 with a permanent magnet 330 attached to or at least partly embedded within the second collar.

In operation, the proximal coupling structure of connector 306 is placed in close proximity to the first coupling structure provided on handle portion. Attractive forces generated by the permanent magnets on or at least partly embedded within the coupling structures cause connector 306 and handle portion to be drawn towards one another and the coupling structures connect to establish a secure magnetic coupling between the magnets. Similarly, the distal coupling structure of connector 306 is placed in close proximity to the second coupling structure provided on cleaning element 308. Attractive forces generated by the permanent magnets on or at least partly embedded within the coupling structures cause connector 306 and cleaning element 308 to be drawn towards one another and the coupling structures connect to establish a secure magnetic coupling between the magnets.

The drive output from handle portion nay be transferred to the drive element (not shown) within connector 306 through first attachment mechanism 310 and from the drive element to cleaning element 308, through second attachment mechanism 311 causing bristles 318 to vibrate. The coupling force generated from engagement of magnets 329, 330 is sufficient to be maintained during application of any operational forces as described above to second attachment mechanism 311. The connector 306 may be detached from the handle portion by applying a pull force sufficient to overcome the attractive force between the permanent magnets in the proximal coupling structure and distal coupling structure. Similarly, connector 306 may be detached from the cleaning element 308 by applying a pull force sufficient to overcome the attractive force between the permanent magnets in the distal coupling structure and second coupling

Generally applicable to embodiments described above the magnetic elements each may be any type of permanent magnet as known to those skilled in the art, for example rare earth magnets such samarium cobalt (SmCo) and Neodymium (NdFeB) or composites such as Alnico (Aluminium-Nickel-Cobalt) and ferrite (prepared from iron oxide and one or more additional metallic elements). Ferrites may include Hard Ferrites such as Strontium Ferrite (SrFe₁₂O₁₉) or Barium Ferrite (BaFe₁₂O₁₉) and Soft Ferrites such as Manganese-zinc ferrite and Nickel-Zinc Ferrite or any combinations thereof. In an embodiment the first, second, third and fourth coupling element is a Neodymium magnet from ProMAG having a diameter of 6.3 mm.

In some embodiments, one or more of the coupling structures described above may include a plurality of permanent magnets, arranged in any suitable configuration to affect a sufficient coupling between the handle, connector and cleaning element.

In some embodiments, at least one of the coupling structures may include a magnetizable material in place of a permanent magnet, such as iron, nickel, cobalt, copper and alloys thereof such as steel. When paired with a coupling structure having a permanent magnet, the permanent magnet/magnetizable material cooperate to form a sufficiently strong magnetic coupling. It should be recognized that while the coupling force between a permanent magnet and a magnetizable material is less that the coupling force between two permanent magnets, such coupling force is still sufficient to maintain the coupling between the handle portion, connector and cleaning element during operation. An additional benefit to this configuration is the lower cost of magnetizable material in comparison to a permanent magnet, thus reducing the cost to users.

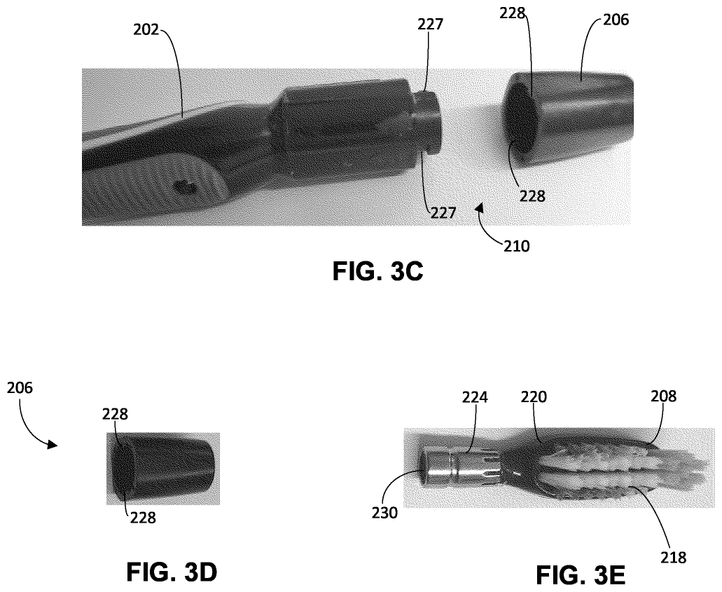

Turning to FIGS. 5A and 5B, a plurality of cleaning elements 108A-D and 508A-M are illustrated as representative examples of bristle materials and configurations. Such examples are merely illustrative, and a person of ordinary skill in the art will appreciate that modifications are possible. Any of the cleaning elements 108A-D and 508A-M may be releasably coupled to a connector of a toothbrush or oral hygiene device by any of the attachment mechanisms described above. Cleaning elements 108A, 108B and 108J include bristles 118A, 118B and 118J respectively manufactured from a suitable material such as Nylon. Cleaning elements 108C-I include bristles 108C-I respectively manufactured from silicon rubber and may be suitable for young children or people with sensitive gums or teeth.

With reference to FIG. 5B, example cleaning elements 508A-M are illustrated. Cleaning elements 508A-M each include respective interdental brushes 508A-M configured to clean between adjacent teeth.

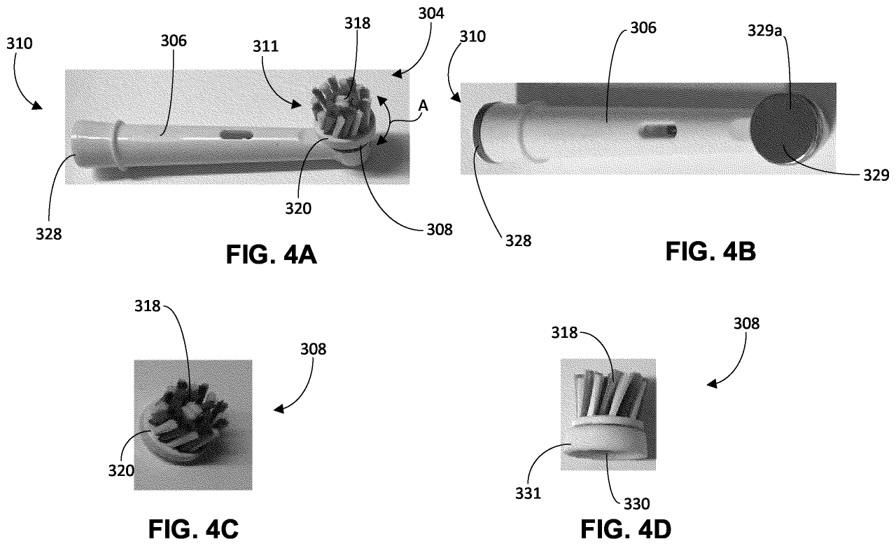

With reference now to FIGS. 6A-C, a brush head 504 is illustrated, which may be generally similar to brush head 104 described above and includes a connector 506 having a housing, first and second attachment mechanisms positioned on the proximal and distal ends of the housing similar to connector 106 and a cleaning element 108, respectively. First attachment mechanism is similar to the magnetic attachment mechanisms described above and includes a proximal coupling structure carrying a magnetic element suitable for establishing a connection with a first coupling structure carrying a magnetic element of a handle portion. Second attachment mechanism 511 includes a distal coupling structure carrying a permanent magnet 529 and is configured for establishing a connection with a second coupling structure carrying permanent magnet 530 positioned on the cleaning element's proximal end. Thus, connector 506 is configured to be repeatedly attached to or detached from a handle portion via the first attachment mechanism and to be repeatedly attached to and detached from the cleaning element 508 via the second attachment mechanism 511, both attachment mechanisms being a magnetic attachment mechanism. The second coupling structure of the cleaning element 508 may also include a protrusion 550 (FIG. 6C) projecting away from its outer surface. Protrusion 550 is configured to be received within channel 552 formed in the outer surface of the proximal coupling structure. Protrusion 550 and channel 552 assist with centring magnets 529, 530 which may be beneficial in maximising the coupling force provided by the second attachment mechanism 511. Further, protrusion 550 and channel 552 may prevent rotation of cleaning element 508 relative to connector 506.

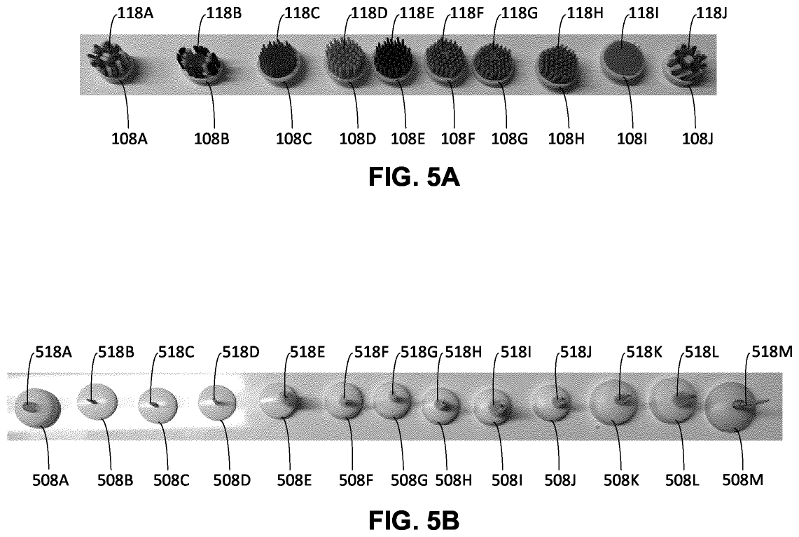

With reference now to FIGS. 7A-C, a brush head 404 is illustrated, Brush head 404 may be similar to brush head 304 and includes a connector 406 to be repeatedly attached to and detached from a handle portion via a first attachment mechanism, such as the magnetic attachment mechanisms described and above, and to be repeatedly attached to and detached from a cleaning element 408 shown with bristles 418 via a second attachment mechanism. In this embodiment, second attachment mechanism 411 is a mechanical attachment mechanism in which connector 406 has a distal coupling structure positioned on the distal end of its housing, the distal coupling structure carrying an engagement device 429. The engagement device 429 is sized and configured to be received in housing 430 carried by the second coupling structure of the cleaning element 408.

Engagement device 429 may be a circular flange with an inner tubular section 429a sized to be received within a cylindrical cavity of housing 430 forming a push fit or snap on connection. Tubular section 429a includes a widened region 429b at the distal end which ensures a secure push fit or snap on connection within housing 430 (FIG. 7C).

Similar to as described above, in operation the drive output from the handle portion is transferred through a drive element (not shown) within connector 406 to cleaning element 408 and bristles 418. The coupling force generated from coupling of engagement device 429 within housing 430 is sufficient to be maintained during application of any operational forces as defined above during operation. However it must be recognized that other types of mechanical connections known in the art may be utilized, such as a twist and lock connection for example.

In some embodiments, the cleaning element may be configured to be push fitted or snapped directly onto the handle of a toothbrush.

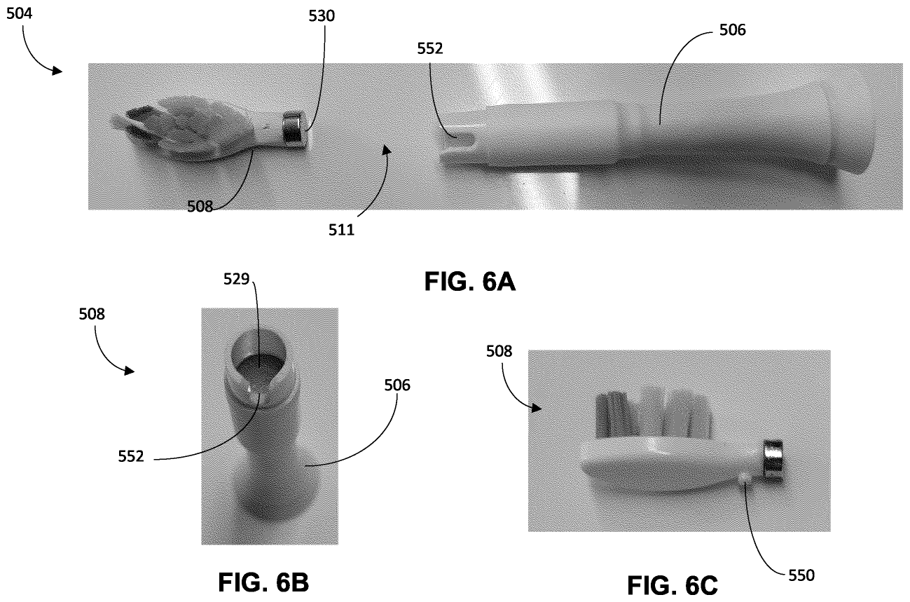

With reference to FIG. 8, connector 606 is depicted which is configured for use with a rotating oscillating electric toothbrush. In this embodiment, the connector 606 may include a first attachment mechanism, such as a magnetic attachment mechanism described above, positioned on the proximal end of the connector's housing including a proximal coupling structure for establishing a connection with a first coupling structure positioned on or attached at the handle's distal end (not shown). Each coupling structure may include a magnetic element for establish a magnetic coupling. The connector 606 also includes a second attachment mechanism including a distal coupling structure positioned on the distal end of the housing of the connector carrying engagement device 629 configured for establishing a connection with a second coupling structure positioned on the proximal end of the cleaning element 608. The second coupling structure includes a housing sized and configured to receive engagement device 629. As shown, the cleaning element 608 is connected to the connector 606 perpendicularly to the connector's axis.

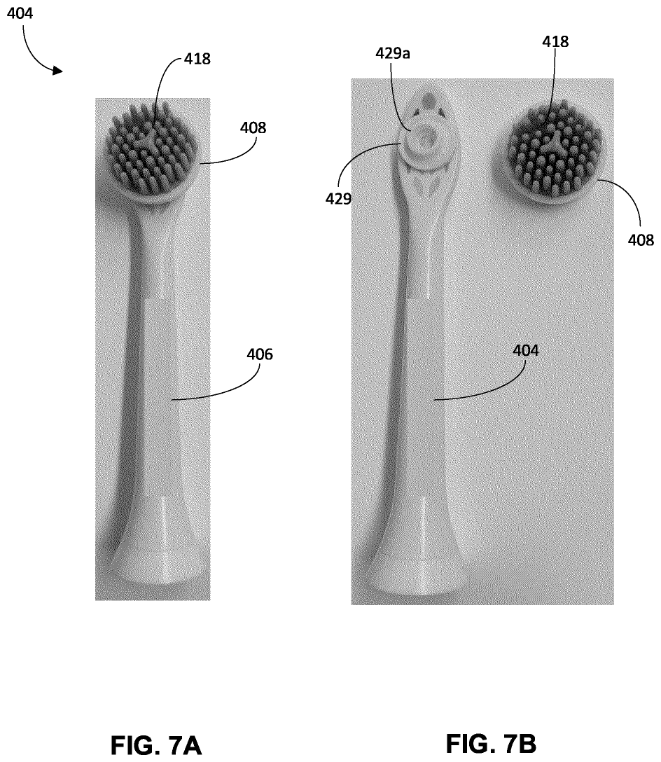

With reference to FIGS. 9A and 9B a connector 706 which may be generally similar to the other connectors described above includes a first magnetic attachment mechanism for repeatedly attaching the connector 706 to a handle and repeatedly detaching the connector from the handle. Connector 706 also includes a second magnetic attachment mechanism for repeatedly attaching connector 706 to a cleaning element and repeatedly detaching the connector from the cleaning element. The first and second attachment mechanisms are positioned at the proximal and distal ends of the connector's housing. The first attachment mechanism includes a proximal coupling structure carrying a magnetic element and is configured for establishing a connection with a first coupling structure carrying a magnetic element provided on the handle. The second attachment mechanism includes a distal coupling structure carrying a magnetic element and is configured for establishing a connection with a second coupling structure carrying a magnetic element provided on the cleaning element.

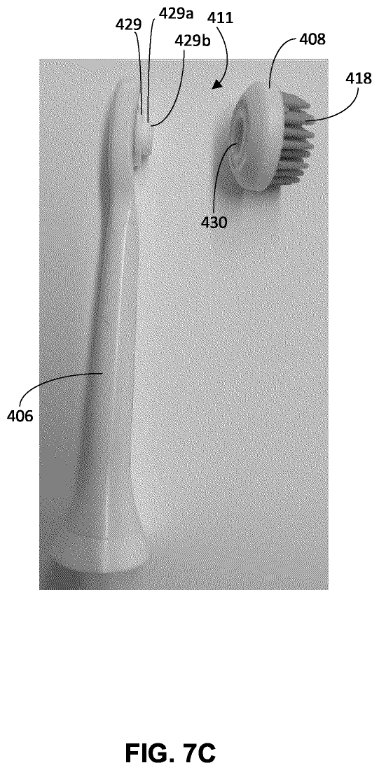

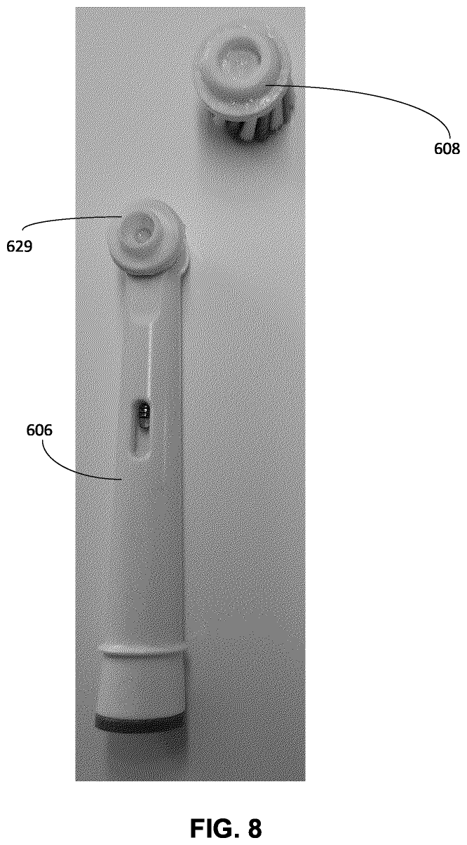

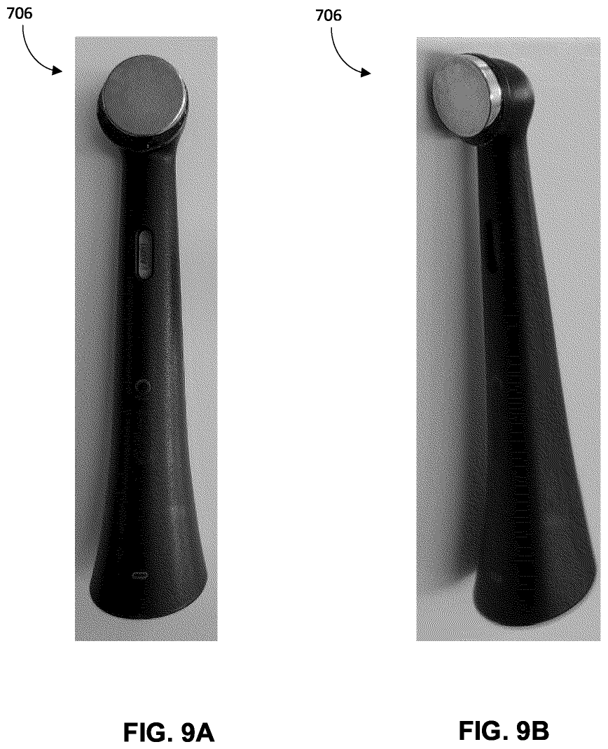

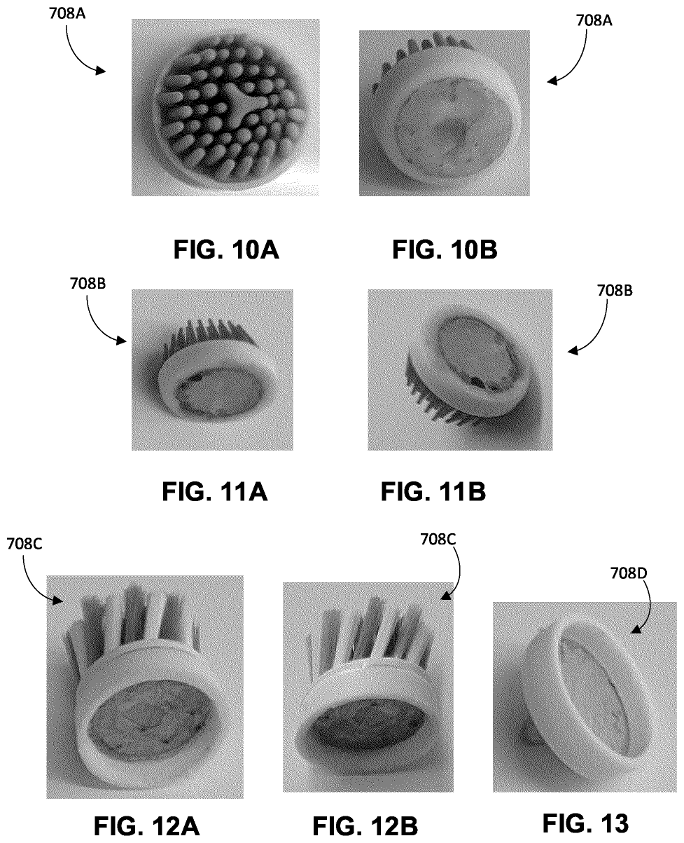

With reference to FIGS. 10A-B, 11A-B, 12A-B and 13, cleaning elements 706A, 706B, 706C and 706D are illustrated which may be repeatedly attached to and detached from a connector or a handle of a toothbrush or oral hygiene device by any of the attachment mechanisms described above.

The first and second attachment mechanisms of the present disclosure may be suitable for use with other oral hygiene devices such as dental finishers, polishing tools, tongue scrapers or flossing devices. For example, the second attachment mechanism of the present disclosure could be used to releasably secure a contouring and polishing disk to a dental polishing tool.

The handle portion, connector, first and second attachment mechanisms, cleaning element, bristles and other parts of the oral hygiene apparatuses of the present disclosure could be made of any suitable material including, but not limited to, a polyester (in particular polyethylene terephthalate, PET, polybutylene terephthalate, PBT, polyethylene naphthalate, PEN, polylactic Acid, PLA, polyhydroxybutyrate and their copolymers), polyamide (in particular PA 6, PA 6.6, PA 6.10, PA 6.12, PA 11, PA 12 and their copolymers), polyethylene (PE) in all its variations, based on density, molecular weight or branching (for example: low, medium or high density, linear or branched, high, ultra-high, low, ultra-low molecular weight and all their combinations), polypropylene, polycarbonate (PC), polystyrene (PS), polymethylmethacrylate (PMMA, including its modifications with comonomers such as methacrylic acid, acrylate, butyl acrylate), acrylonitrile butadiene styrene (ABS), polyvinylchloride, polyether sulfone, polyetherether ketone, polyetherimide, polyphenyleneoxide, metal, synthetic rubber, natural rubber, silicone, nylon, wood, plastics containing a proportion of recycled materials, bioplastics or materials comprising a proportion of bioplastics. Suitable bioplastics include, but are not limited to starch-based bioplastics, cellulose-based bioplastics, protein-based bioplastics, aliphatic polyesters, organic polyetheylene, polyhydroxyalkanoates (PHA), polyhydroxyvalerate (PHV), polylactic acid (PLA) and polyhydroxyhexanoate (PHH). Such bioplastics may be biodegradable or compostable.

The components of the brush head of the present disclosure may be manufactured by means of manual fabrication, extrusion, mold injection, casting, 3D printing, CNC fabrication or templating.

While the foregoing is directed to various embodiments of the present disclosure, other and further embodiments of the disclosure may be devised without departing from the basic scope thereof, and the scope thereof is determined by the claims that follow.

1. A connector for repeatedly attaching to and detaching from a handle portion and a cleaning element of an oral hygiene device comprising:
a housing having a proximal end and a distal end;
a first attachment mechanism positioned at the proximal end of the housing, the first attachment mechanism comprising a proximal coupling structure configured for establishing a connection with a first coupling structure provided on the handle portion; and
a second attachment mechanism positioned at the distal end of the housing, the second attachment mechanism comprising a distal coupling structure configured for establishing a connection with a second coupling structure provided on the cleaning element
wherein the proximal coupling structure includes a magnetic element capable of magnetically coupling with a corresponding magnetic element carried by the first coupling structure and the distal coupling structure includes a magnetic element capable of magnetically coupling with a corresponding magnetic element carried by the second coupling structure.

2. The connector of claim 1, wherein the housing comprises a bioplastic.

3. A brush head for repeatedly attaching to and detaching from a handle portion of an oral hygiene device comprising:
a cleaning element comprising a body and a first coupling structure positioned on the body wherein the first coupling structure comprises a first magnetic element; and
a connector comprising (i) a housing having a proximal end and a distal end, (ii) a first attachment mechanism positioned at the proximal end of the housing, the first attachment mechanism comprising a proximal coupling structure configured for establishing a connection with a second coupling structure provided on the handle portion wherein the proximal coupling structure includes a magnetic element capable of magnetically coupling with a corresponding magnetic element carried by the second coupling structure, and (iii) a second attachment mechanism positioned at the distal end of the housing, the second attachment mechanism comprising a distal coupling structure configured for establishing a connection with the first coupling structure of the cleaning element wherein the distal coupling structure includes a magnetic element capable of magnetically coupling with the first magnetic element carried by the second coupling structure.

4. The brush head of claim 3, wherein the body of the cleaning element and the housing of the connector comprise a bioplastic.

5. A oral hygiene device comprising:
a handle portion comprising a housing having a proximal end and a distal end and a second coupling structure positioned at the distal end comprising a magnetic element; and
the brush head of claim 3.

6. A kit comprising the connector of claim 1 and a plurality of cleaning elements.
